(19) United States
(12) Patent Application Publication
(10) Pub. No.: US 2024/0048648 A1
(43) Pub. Date: Feb. 8, 2024

(54) Portable wireless charger that attacks to the cell phone case

(71) Applicant: Gilbert Hess, Ocala, FL (US)

(72) Inventor: Gilbert Hess, Ocala, FL (US)

(21) Appl. No.: 17/803,488

(22) Filed: Aug. 5, 2022

(51) Int. Cl. H04M 1/04; H02J 50/10; F21V 23/04; F21V 33/00; G10K 9/122; H04M 1/21; F41H 13/00

(52) U.S. Cl. CPC H04M 1/04; H02J 50/10; F21V 23/0407; F21V 33/0076; G10K 9/122; H04M 1/21; F41H 13/0087

(57) ABSTRACT

A portable charger that attaches to a cell phone case by the use of magnets and metal plates over molded into the plastic phone case and doubles as a passive self defence device with a strobe light and alarm.

### BACKGROUND OF THE INVENTION

Cell phone chargers have been around for years, even wireless chargers that plug-in the 110 wall outlet. They are to be used by placing the cell phone on the wireless transmitter coil device. They are not portable.

This portable wireless charger attaches to the back of the cell phone case by the use of small metal plates over molded into the plastic phone case and a plurality of magnets in the detachable portable wireless charger.

This wireless charger for the cell phone when attached to the phone provides twice the phones battery capacity.

It would therefore be desirable to provide a charger that attaches to a cell phone case making it readily available when needed.

### SUMMARY OF INVENTION

Aspects of this invention are advantageous to anyone away from home and a plug-in charger with a low cell phone battery.

In accordance with one aspect of the invention, the portable charger can be stored in a purse or pocket although it is preferred to be used attached to the cell phone.

There are many flashlights on the market with a strobe light function and many different devices with an alarm function including personal alarms made for key chains. There are also many cell phone chargers in the public domain. This invention includes all three of these devices but in a more useful package.

### BRIEF DESCRIPTION OF DRAWINGS

The drawings should be understood to present an illustration of various aspects of the invention and/or principles involved, and not to limit the scope of the subject matter as set forth in the claims.

FIG. 1. shows the portable wireless charger that doubles as a passive self defence device attached to the cell phone case.

FIG. 2. shows the interior of the portable wireless charger that doubles as a passive self defence device.

FIG. 3. shows the exterior and interior of lid.

FIG. 4. shows cell phone case with over molded metal plates.

### DETAILED DESCRIPTION OF THE DRAWINGS

The present invention relates to a portable wireless charger for the cell phone that attaches to the cell phone case and doubles as a passive self defence device.

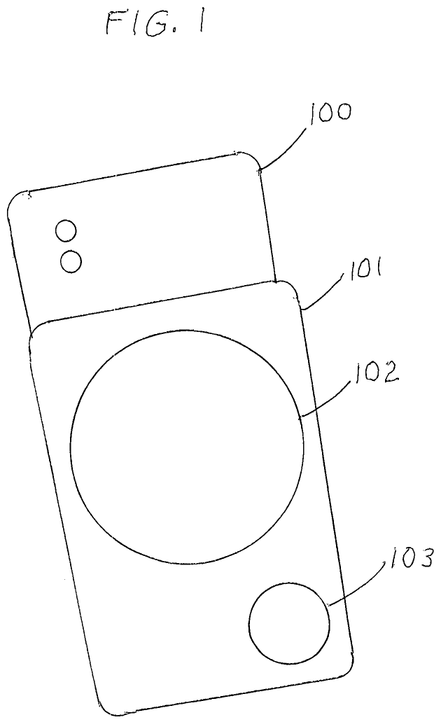

In FIG. 1. the representative wireless charger that doubles as a passive self defence device, 101 emits a tightly focused strobed beam of light and is attached to a cell phone case, 100. The optic, 102 provides the strobe function. The hole, 103 for the piezo electric, 110 which provides the sound for alarm when activated.

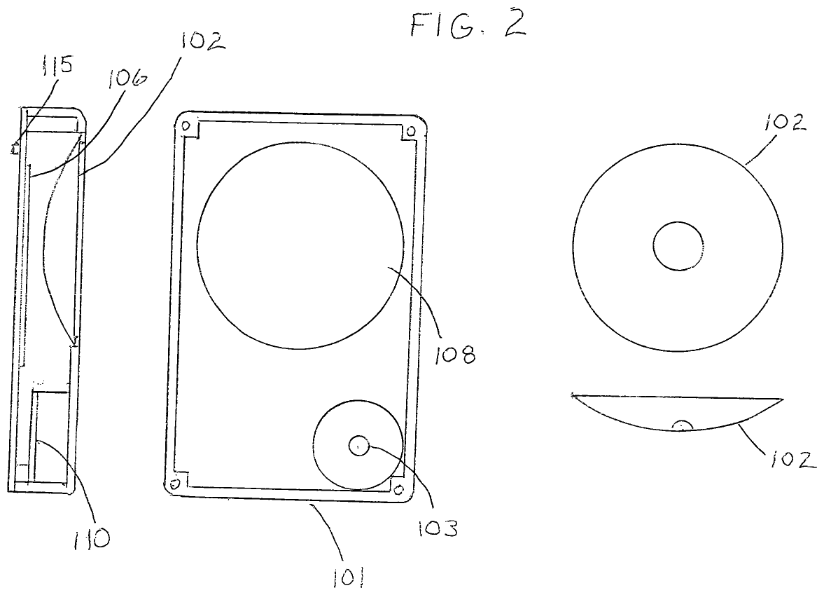

FIG. 2 of the drawings show the wireless transmitter coil, 106 on the inside back of lid, 107. Also shown is the interior of the portable wireless charger that doubles as a passive self defence device, 101 and the optic, 102. The round 55 mm dia. opening, 108 is for the 60 mm dia. optic, 102.

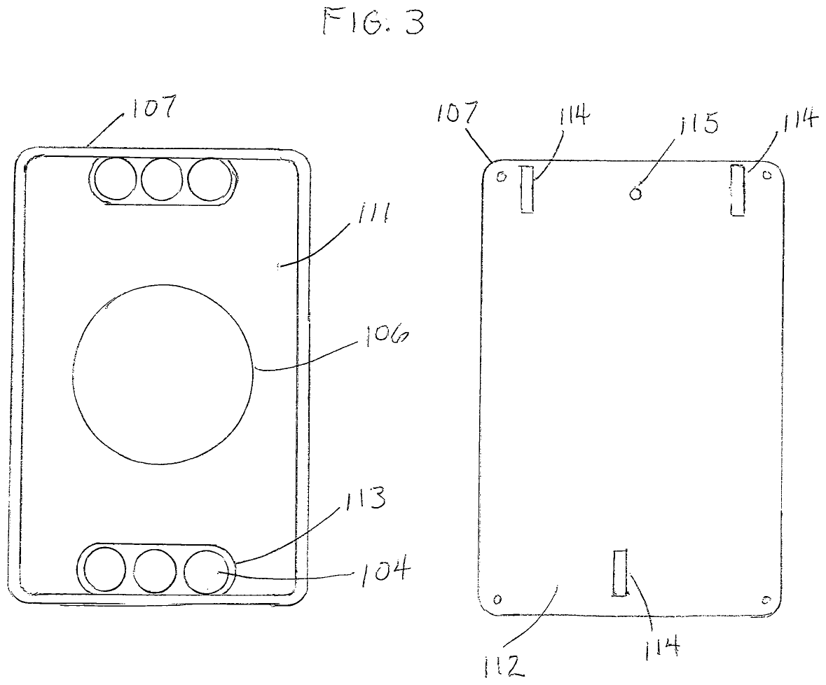

In FIG. 3 the exterior, 112 and interior, 111 of the portable wireless charger's lid, 107. The interior, 111 shows the magnet holders, 113 in the interior, 111 having a plurality of 6 magnets, 104 3.0 mm in dia. secured in place by reassess, 113 in the lids, 107 interior, 111 that holds the portable wireless charger, 101 to the cell phone case, 100 metal plates, 105.

The exterior, 112 of the lid, 107 shows the three plastic bars, 114 that hold the charger, 101 in place keeping it from sliding side to side. The round plastic post, 115 is used to position the charger, 101 in place on the cell phone case, 100 by fitting the plastic post, 115 into the hole, 116 in the metal plate, 105 on the cell phone case, 100.

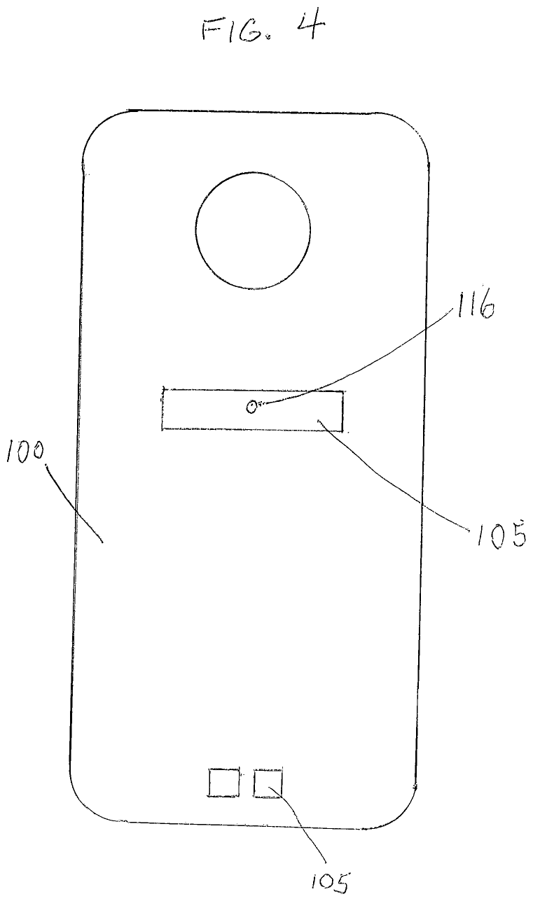

FIG. 4 shows the cell phone case, 100 with the three metal plates, 105 over molded into the plastic cell phone case, 100. The metal plate, 105 at the top of the cell phone case, 100 fits between the two plastic bars, 114 on the exterior, 112 of the lid, 107 keeping the charger, 101 in place.

Certain modifications and improvements will occur to those skilled in the art upon reading the foregoing description. It should be understood that all such modifications and improvements have been omitted for the sake of conciseness and readability, but are properly within the scope of the following claims.

What is claimed is:

1. A portable wireless charger that attaches to the back of a cell phone case that doubles as a passive self defence device comprising:
a narrow focused optic, a power source, a strobe driver, a piezo electric and driver for the alarm and one or more LED's.

2. A portable wireless charger that doubles as a passive self defence device of claim 1 characterized by a means controlling the electrical power to the LED comprising a switch that turns the LED on and off and operable by the user.

3. A portable wireless charger that doubles as a passive self defence device of claim 2. characterized by using a strobe driver to flash the LED.

4. A portable wireless charger that doubles as a passive self defence device of claim 3. characterized by using an optic that produces a ultra narrow tightly focused beam.

5. A portable wireless charger that doubles as a passive self defence device of claim 4. characterized by using a power source, such as a rechargeable battery.

6. A portable wireless charger that doubles as a passive self defence device of claim 5. characterized by using a substantially flat rectilinear configuration of 0.75″×4″×2.75″.

7. A portable wireless charger that doubles as a passive self defence device of claim 1. characterized by using a wireless transmitter coil to charge cell phone.

8. A portable wireless charger that doubles as a passive self defence device of claim 1. characterized by using a means of attaching the charger to the cell phone case using a plurality of magnets that fit into the chargers back plastic cover (lid).

9. A portable wireless charger that doubles as a passive self defence device of claim 8. characterized by using any other reasonable means for attachment, such as plastic snaps to hold charger on cell phone case.

10. A portable wireless charger that doubles as a passive self defence device of claim 1. characterized by using cell phone cases with small metal plates over molded into the plastic cell phone back cover to hold the safety device in place.
